(19) United States
(12) Patent Application Publication
(10) Pub. No.: US 2011/0076524 A1
(43) Pub. Date: Mar. 31, 2011

(54) Fuel Cell Power System and Operating Method Thereof

(75) Inventors: Yoshiyuki Takamori, Hitachinaka (JP); Shuichi Suzuki, Hitachinaka (JP); Makoto Morishima, Hitachinaka (JP); Jun Kawaji, Hitachi (JP)

(73) Assignee: Hitachi, Ltd., Tokyo (JP)

(21) Appl. No.: 12/855,342

(22) Filed: Aug. 12, 2010

(30) Foreign Application Priority Data
Sep. 30, 2009 (JP) 2009-225892

(51) Int. Cl. H01M 12/08

(52) U.S. Cl. 429/9

(57) ABSTRACT

A fuel cell power system and an operating method thereof are proposed in which, the power generation performance of the fuel cell is effectively recovered in a short period of time without additionally requiring any reducing agent or an inactive gas and while minimizing the degradation of the catalyst in use. The fuel cell power system includes a fuel cell stack in which a plurality of cells each having a membrane electrode assembly and a separator are stacked and a secondary battery which can be charged by power generated by the fuel cell stack. The fuel cell power system can supply power from either the fuel cell stack or the secondary battery to an external device. The fuel cell power system is provided with a power generation cell connection/disconnection mechanism for individually connecting and disconnecting a conductor for electrical conduction between the anode and cathode of each cell included in the fuel cell stack which controlled by a control unit.

### CLAIM OF PRIORITY

The present application claims priority from Japanese Patent Application No. 2009-225892 filed on Sep. 30, 2009, the content of which is hereby incorporated by reference into this application.

### BACKGROUND OF THE INVENTION

1. Field of the Invention

The present invention relates to a fuel cell power system and an operating method thereof.

2. Description of the Related Art

Thanks to the recent advance of electronic technology, portable electronic devices such as telephones, notebook computers, audio/visual devices, camcorders, and personal information terminals have been rapidly spreading among people. To drive such portable electronic devices, secondary batteries have been used. As increasingly advanced secondary batteries, ranging from sealed lead acid batteries to nickel cadmium batteries and nickel hydrogen batteries or to lithium-ion secondary batteries which are a new type of secondary batteries with a high energy density, have become available, portable electronic devices have been made smaller and lighter while their functions have been enhanced. With an aim to further increase the energy density of the above mentioned kinds of secondary batteries, lithium ion secondary batteries in particular, work for developing a better battery active material and a higher-capacity battery structure has been proceeded. Thus, efforts are being made to realize power supplies which can be used longer per charge.

Secondary batteries, however, inevitably require to be charged after a certain amount of power is consumed, and charging a secondary battery requires a charging device and a comparatively long charging time. Thus, there are many problems to be solved before portable electronic devices can be driven continuously for a long period of time anytime and anywhere. To cope with an increasing volume of information to be processed, portable electronic devices will continue to be made faster in operation and higher in function. Namely, they will continue requiring power supplies with a higher output density and a higher energy density, i.e. power supplies capable of continuously driving a device for a long period of time, and there is increasing need for a compact generator which need not be charged, i.e. a micro-generator which can be easily replenished with fuel.

Under the present circumstances, a fuel cell power system may be a solution which can meet the above requirements. A fuel cell is a power generator including at least a solid or liquid electrolyte and two electrodes, i.e. anode and cathode which can induce a desired electrochemical reaction. A fuel cell directly converts the chemical energy of a fuel into an electric energy with high efficiency.

The fuels generally used for a fuel cell include oxygen chemically converted from a fossil fuel or water; methanol, alkali hydride and hydrazine which stay as a liquid or solution in a normal environment; and dimethyl ether which is a pressurized liquefied gas. A fuel cell also uses air or oxygen gas as an oxidant gas.

The fuel fed to the anode of a fuel cell is electrochemically oxidized while the oxygen fed to the cathode is reduced, generating a difference in electric potential between the anode and the cathode. In this state, connecting a load, i.e. an external circuit, across the anode and the cathode induces ion movement through the electrolyte to provide the external circuit with an electric energy. Today, high hopes are placed on various kinds of fuel cells for applications such as large power generation systems to replace thermal power equipment, small distributed cogeneration systems, and power supplies for electric vehicles to replace gasoline engines, and work to develop practical applications of fuel cells is being actively promoted.

Among various kinds of fuel cells, direct methanol fuel cells (DMFC) operated using a liquid fuel, metal hydride fuel cells, and hydrazine fuel cells use fuels with a high volumetric energy density, so that they have been collecting attention as being effectively usable as compact transportable or portable power supplies. Particularly, DMFC operated using methanol as a fuel which may be producible from biomass in the near future may be said to make ideal power supply systems.

There is, however, a problem with DMFC in which, when a DMFC continues power generation for a long period of time, its power generation performance is gradually degraded and the DMFC possibly enters a state where it can no longer generate required power. To cope with such a problem, a technique is disclosed in EP1263070A2 in which, when a DMFC system is used to supply power to a load continuously for a long period of time, output of the fuel cell is reduced (stopped) periodically (every 30 minutes to four hours) putting the fuel cell in an open-circuit state. In an another technique which is disclosed in JP-A No. 2007-273460, as a method of activating a fuel cell, a reducing agent or an inactive gas is supplied to the cathode of the fuel cell whereas an electric conductor is disposed between the cathode and the anode to keep the potential difference between the cathode and the anode to or below 100 mV.

In the fuel cell activation method disclosed in EP1263070A2, however, the fuel cell is put in an open-circuit state at relatively short intervals, i.e. every 30 minutes to four hours, causing the cathode of the fuel cell to be exposed to a high-potential environment at the same intervals. This results in accelerating the degradation of the cathode catalyst. In addition, it has been found that recovering the performance of a fuel cell just by reducing (stopping) its output putting it in an open-circuit state takes much time or such a method may not even allow the fuel cell to adequately recover its performance. Furthermore, in EP1263070A2, how the electronic device connected to the fuel cell is powered while the output of the fuel cell is reduced (stopped) is not described.

As for the fuel cell activation method described in JP-A No. 2007-273460, to introduce a reducing agent or an inactive gas to the cathode of a fuel cell requires such a reducing agent or inactive gas to be prepared along with a pump for feeding the reducing agent or inactive gas. This will make the fuel cell system more complicated and larger.

An object of the present invention is to provide a fuel cell power system and an operating method thereof which make it possible, when the power generation performance of a fuel cell is degraded after power generation by the fuel cell is continued for a long period of time, to effectively recover the power generation performance of the fuel cell in a short period of time without additionally requiring any reducing agent or an inactive gas and while minimizing the degradation of the catalyst in use.

### SUMMARY OF THE INVENTION

The present invention provides a fuel cell power system and an operating method thereof. The fuel cell power system includes a DMFC used as a power supply having a built-in secondary battery which can be charged as an auxiliary power supply and a DMFC stack which, serving as a power generation unit, includes plural cells for power generation. The DMFC can supply power to an external device either directly or via the built-in secondary battery.

The DMFC has, for each cell included in the DMFC stack, a conductor for electrical conduction between the anode and cathode of each cell. The fuel cell power system and the operating method thereof make it possible, when the power generation performance of the DMFC degrades, to recover the power generation performance of the DMFC by: causing the secondary battery to be periodically switched to as a power supply for an external device; stopping power generation by the DMFC; stopping oxidant supply to the cathode of each cell; and electrically connecting the anode and cathode of each cell using the conductor for each cell.

A fuel cell power system according to the present invention includes a fuel cell stack in which a plurality of cells each having a membrane electrode assembly and a separator are stacked and a secondary battery which can be charged by power generated by the fuel cell stack and is capable of supplying power from one of the fuel cell stack and the secondary battery to an external device. The fuel cell power system comprises: a power generation cell connection/disconnection mechanism for individually connecting and disconnecting a conductor for electrical conduction between an anode and a cathode of each cell included in the fuel cell stack; and a control unit for controlling connection/disconnection operation performed by the power generation cell connection/disconnection mechanism.

In the fuel cell power system, when power generation by the fuel cell stack is continued for a predetermined amount of time: the power generation is stopped; air supply to the cathode of each cell included in the fuel cell stack is stopped; the power generation cell connection/disconnection mechanism is caused to electrically connect the anode and cathode of each cell included in the fuel cell stack; the electrical connection between the anode and cathode is broken; air supply to the cathode is resumed; and power generation by the fuel cell stack is resumed.

In the fuel cell power system, there is further provided a voltage sensor for measuring a voltage of the fuel cell stack and, when a voltage measured by the voltage sensor is lower than a predetermined voltage value, power generation by the fuel cell stack is stopped; air supply to the cathode of each cell included in the fuel cell stack is stopped; the power generation cell connection/disconnection mechanism is caused to electrically connect the anode and cathode of each cell included in the fuel cell stack; the electrical connection between the anode and cathode is broken; air supply to the cathode is resumed; and power generation by the fuel cell stack is resumed.

In the fuel cell power system, stopping power generation, stopping air supply, and then electrically connecting the anode and cathode of each cell causes the residual oxygen present on the cathode side of the fuel cell stack to be immediately consumed by an electrochemical reaction. This causes the potential of the cathode of each cell to drop and the oxide formed on the cathode catalyst surface to be reduced. As a result, the catalyst is reactivated and, when power generation is resumed, the performance of the fuel cell stack is effectively recovered.

According to the present invention, a DMFC can be stably operated for a long period of time while maintaining high performance without stopping power supply to a device conned thereto.

### BRIEF DESCRIPTION OF THE DRAWINGS

FIG. 1 is a block diagram of an example configuration of a DMFC system according to an embodiment of the present invention.

FIG. 2 is a flowchart of performance recovery operation for a fuel cell stack according to a first embodiment.

FIG. 3 is a flowchart of performance recovery operation for a fuel cell stack according to a second embodiment.

FIG. 4 is a diagram showing results of comparison made, in terms of performance recovery effects, between embodiments of the present invention and a comparative example.

### DETAILED DESCRIPTION OF THE PREFERRED EMBODIMENTS

Embodiments of the present invention will be described. The embodiments described below are direct methanol fuel cells (DMFC) which generate power by supplying an aqueous methanol solution to each anode and oxygen (air) to each cathode, but similar advantageous effects can be obtained also by using fuel cells to generate power using an alcohol fuel other than methanol or a fuel cell power system using hydrogen as a fuel.

According to the following embodiments, the power generation performance of a DMFC can be recovered without stopping power supply to a device connected to the DMFC, so that it is possible to continuously operate an electronic device powered by a fuel cell longer than before. Also, since degradation of cells can be inhibited, the fuel cells can be stably used longer.

Embodiments of a fuel cell power system and an operating method thereof according to the present invention will be described below with reference to the accompanying drawings.

### First Embodiment

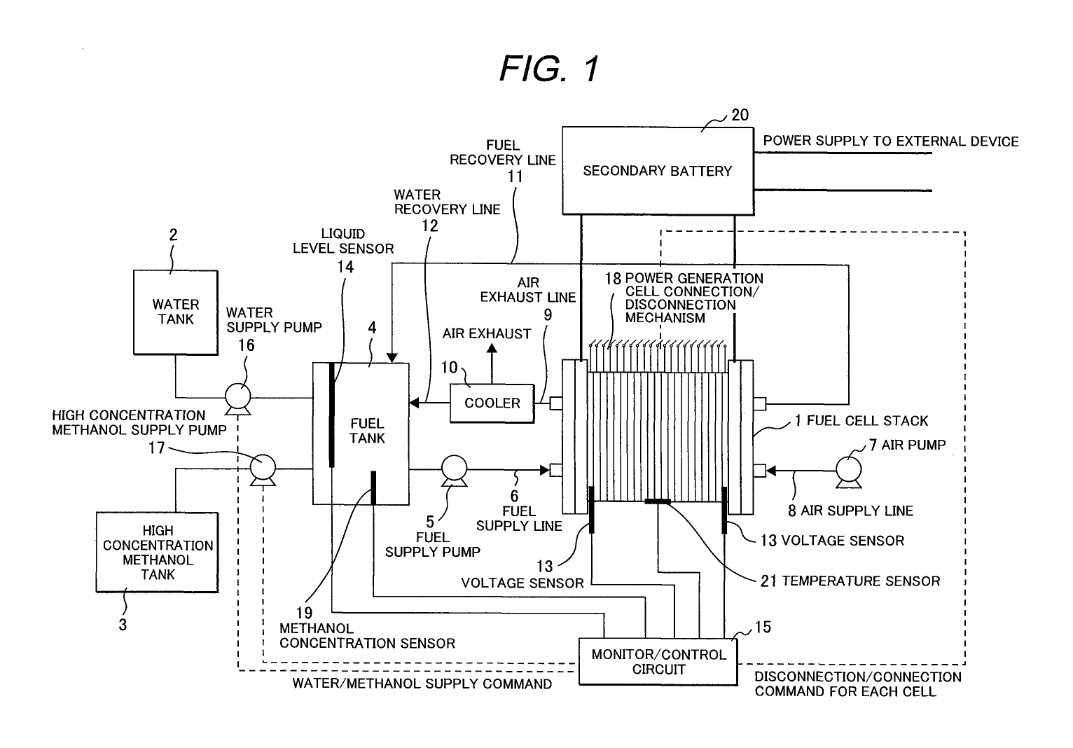

FIG. 1 shows an example basic configuration of a DMFC system according to a first embodiment of the present invention. The DMFC system includes a fuel cell stack 1 serving as a power generation unit, a fuel tank 4 for supplying fuel to the fuel cell stack 1, a liquid level sensor 14 for detecting a fuel decrease in the fuel tank 4 as a result of fuel consumption, a fuel supply pump 5, a water tank 2 for replenishing the fuel tank 4 with fuel to make up for the fuel consumed for power generation, a water supply pump 16, a high concentration methanol tank 3, a high concentration methanol supply pump 17.

And, also includes an air pump 7 for supplying air to the fuel cell stack 1, a power generation cell connection/disconnection mechanism 18 for electrically connecting/disconnecting each power generation cell included in the fuel cell stack 1, a secondary battery 20 for storing power generated by the fuel cell stack 1 or supplying power to an external device, and a monitor/control circuit 15 for monitoring the liquid level sensor 14 and controlling such operations as connection/disconnection of each power generation cell performed by the power generation cell connection/disconnection mechanism 18 and charging/discharging of the secondary battery 20. 21 is a temperature sensor.

The fuel cell stack 1 includes plural cells stacked and connected in series with each cell having a membrane electrode assembly (MEA) and a separator and generates power by having an aqueous methanol solution and air supplied thereto. To operate the fuel cell power system for a long period of time in a stable state, it is necessary to periodically recover the performance, degrading through continuous power generation, of the fuel cell stack 1.

The power generation cell connection/disconnection mechanism 18 includes, for each cell, a conductor for electrical conduction between the anode and cathode and a mechanism for switching the conduction on/off.

In the present embodiment, to stably operate the DMFC system, the power generation by the fuel cell stack 1 is periodically stopped and, after stop of the power generation, the anode and cathode of each cell are connected by the power generation cell connection/disconnection mechanism 18.

In the DMFC system shown in FIG. 1, fuel required for power generation is supplied, by driving the fuel supply pump 5, from the fuel tank 4 to the fuel cell stack 1 via a fuel supply line 6. The fuel supplied to the fuel cell stack 1 is fed to each cell to be consumed for power generation. The portion of the fuel not consumed for power generation is discharged from the fuel cell stack 1 to be returned to the fuel tank 4 via a fuel recovery line 11. The methanol concentration in the fuel tank 4 is kept in a range which allows the DMFC system to be stably operated by the monitor/control circuit 15 that monitors a methanol concentration sensor 19 and, depending on the concentration monitored, drives the high concentration methanol supply pump 17 and the water supply pump 16.

Oxygen for use in power generation is supplied to the fuel cell stack 1 via an air supply line 8 by driving the air pump 7. The air supplied to the fuel cell stack 1 is fed to each cell allowing the oxygen contained therein to be consumed for power generation and is then released from the fuel cell stack 1 to the atmosphere. To stably supply air for use in power generation, the monitor/control circuit 15 controls the air pump drive voltage according to the operating condition of the DMFC system.

The DMFC system controlled as described above can be stably operated to supply power to an external device. When, however, the DMFC system is continuously operated for a long period of time, the performance of the fuel cell stack 1 is gradually degraded to a state where it cannot supply required power any longer. Hence, it is necessary to periodically perform performance recovery operation for the fuel cell stack 1.

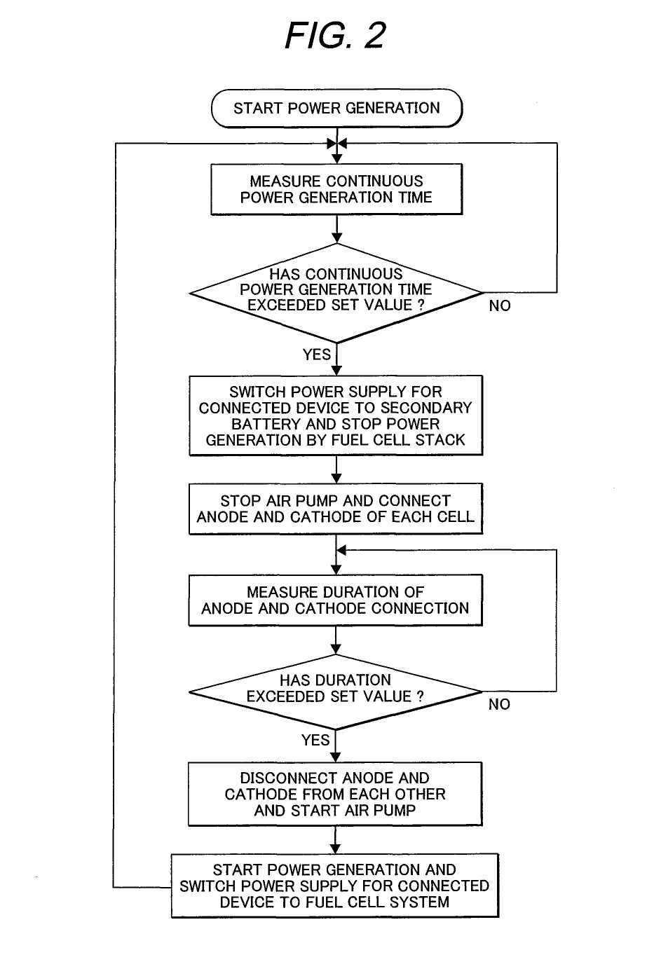

FIG. 2 is a flowchart of performance recovery operation to be performed for the fuel cell stack 1 when its power generation performance degrades after long continuous power generation. First, after the DMFC system starts power generation, the time of continuous power generation is measured. Next, whether the continuous power generation time has exceeded a predetermined value is determined. When it is determined that the predetermined value has not been exceeded, performance recovery operation is not performed and execution returns to the step for measuring the continuous power generation time. When it is determined that the predetermined value has been exceeded, the performance recovery operation is required to be performed, so that, according to the flowchart, the power supply for the connected device is switched from the DMFC system to the secondary battery 20 and power generation by the fuel cell stack 1 is stopped.

Next, the air pump 7 is stopped to stop air supply to the cathode of each cell. At the same time, the anode and cathode of each cell are connected by operating the power generation cell connection/disconnection mechanism 18 and the duration of their connection is measured. Next, whether the duration of their connection has exceeded a predetermined amount of time is determined. When it is determined that the duration of their connection has not exceeded the predetermined amount of time, the anode and cathode of each cell are kept connected with air supply stopped. When it is determined that the duration of their connection has exceeded the predetermined amount of time, execution proceeds according to the flowchart causing the anode and cathode of each cell to be disconnected from each other, the air pump 7 to be restarted to resume air supply, and the fuel cell stack 1 to resume power generation. Subsequently, power supply for the connected device is switched from the secondary battery 20 back to the DMFC system.

Even though not described in the flowchart, when air supply is stopped, fuel supply may also be stopped. By stopping the fuel supply, both the methanol crossover during the time when power generation is stopped and the power consumption for fuel supply can be reduced.

Performing the above procedure recovers the fuel cell performance. The mechanism of the fuel cell performance recovery will be briefly described below. The causes of performance degradation of a fuel cell include degradation of the cathode catalyst activity. The cathode catalyst activity is degraded, for example, by catalyst oxidation or when methanol crossing over to the cathode side during power generation by the fuel cell burns on the cathode and its oxidation ends while it is partly in a state of CO allowing the CO to subsequently poison the cathode catalyst.

In a fuel cell power system, immediately after power generation, methanol supply, and air supply is stopped, the fuel cell circuit is in an open state with residual air (oxygen) remaining at the cathode of each cell, so that the cathode is in a high-potential (up to 1 V) state. When, in that state, the cell is short-circuited, the following cell reaction occurs at each electrode of the cell, consuming the cathode oxygen and lowering the cathode potential.

Anode: CH₃OH+H₂O [symbol] CO₂+6H⁺+6e

Cathode: 6H⁺+ 3/2O₂+6e [symbol] 3H₂O

When the potential of a cathode lowers, the surface oxide generated by partial oxidation of a cathode catalyst (for example, platinum oxide in cases where platinum is used as a catalyst) is reduced to recover catalyst activity which has been degraded due to oxidation.

As for the case of performance degradation during continuous operation in which methanol crossing over to the cathode side burns on a cathode and its oxidation ends while it is partly in a state of CO allowing the CO to subsequently poison the platinum used as a cathode catalyst, the catalyst can be reactivated as follows.

After stopping power generation, short circuit each cell, consume the residual oxygen, and restart air supply to the cathode. Immediately after the air supply is restarted, an air (oxygen) concentration gradient is formed between the air inlet and outlet of the cathode. To be concrete, the inlet side enters an oxygen-rich state while the outlet side where oxygen has not reached is left in an oxygen-less state. When, in that state, power generation is resumed, a local cell is formed in the electrodes due to an oxygen concentration difference. This cell reaction causes the CO poisoning the catalyst to disappear allowing the catalyst to be reactivated.

As described above, in the performance recovery operation according to the present embodiment, stopping power generation by a fuel cell power system, stopping air supply, and then electrically connecting the anode and cathode of each cell causes the residual oxygen present on the cathode side of the fuel cell stack to be immediately consumed by an electrochemical reaction. This causes the potential of the cathode of each cell to drop and the oxide formed on the cathode catalyst surface to be reduced. As a result, the catalyst is reactivated and, when power generation is resumed, the performance of the fuel cell stack is effectively recovered.

Thus, even in cases where the performance of the fuel cell stack 1 is degraded during a long period of power generation, the performance of the fuel cell stack 1 can be recovered without suspending the power supply to the connected device. This enhances the reliability and extend the life of the DMFC system.

Even though, in the present embodiment, the anodes and cathodes of individual cells are connected not altogether for the whole stack but individually, the same effect will be obtained also by connecting them altogether for the whole cell stack. Namely, the oxide formed on the cathode catalyst surface will be reduced by an electrochemical reaction similar to the above-described and the catalyst will be reactivated.

In cases where the anodes and cathodes of all cells included in the cell stack are connected altogether, however, it will take time for the cathode potential to drop, so that performance recovery also takes time.

Also, generally, the residual amounts of fuel and oxygen differ between cells. In cases where the anodes and cathodes of all the cells included in the cell stack are connected altogether, when there is oxygen remaining in the stack, a chemical reaction occurs causing an electrical current to flow through the stack even if there are also some oxygen-less cells in the stack. When it occurs, the cells without adequate oxygen supplement oxygen themselves, for example, by dissolving water or components of an MEA. When water is dissolved, hydrogen peroxide which detrimentally affects the MEA is generated. When components of the MEA are dissolved, functions of the MEA are affected to possibly damage the MEA.

In cases where, as in the present embodiment, the anodes and cathodes of individual cells are connected individually, when the oxygen residual on the cathode side of a cell is consumed, the cathode potential drops to cause no electric current to flow through the anode and cathode of the cell, so that, unlike in the above-described case, no damage is caused to the MEA. Furthermore, electrochemical reactions in individual cells occur individually, so that an electrochemical reaction occurring in a cell causes the residual cathode oxygen in the cell to be consumed and the cathode potential to drop without being affected by other cells.

This reduces the total time required before the cathode potential drops for all the cells included in the stack. For these reasons, it is preferable to connect the anodes and cathodes of individual cells individually.

Even though, in the present embodiment, it is assumed that the DMFC in a normal power generating state supplies power to a device connected thereto, the power generated by the DMFC may be used, instead of supplying the power directly to the connected device, to charge the secondary battery 20 allowing the connected device to be powered by the secondary battery 20. In that case, switching the power supply for the connected device before stopping or resuming power generation as described in the flowchart shown in FIG. 2 is not necessary.

### Second Embodiment

In a second embodiment, the performance recovery operation for the fuel cell stack 1 is performed not every time power generation is continued for a predetermined amount of time but when a cell voltage being monitored drops below a predetermined value. Hence, in the second embodiment, a voltage sensor 13 attached to the fuel cell stack 1 as shown in FIG. 1 is used.

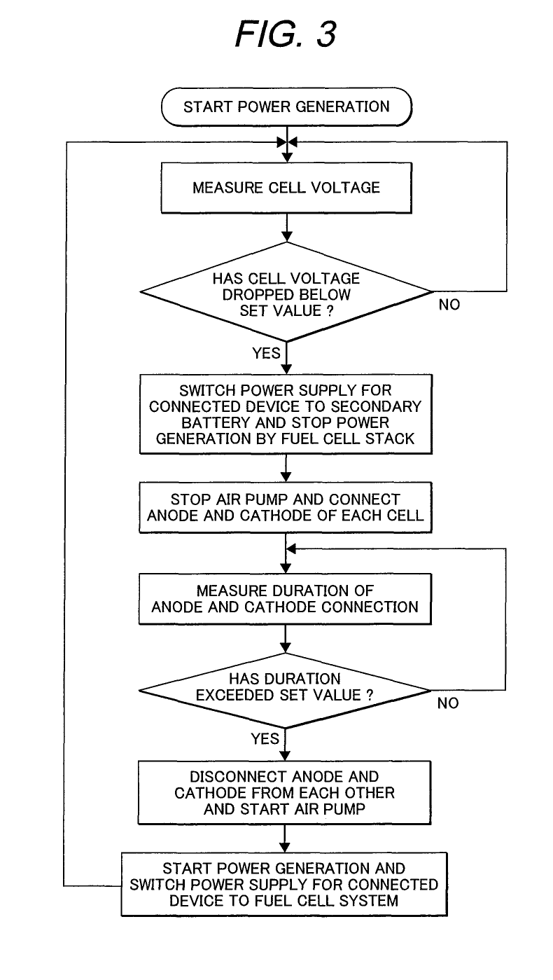

FIG. 3 is a flowchart of the performance recovery operation performed for the fuel cell stack 1 according to the second embodiment. In the second embodiment, when to switch the power supply for the connected device from the fuel cell stack 1 to the secondary battery 20 and when to stop power generation is determined based on the cell voltage measured using the voltage sensor 13. In other respects, the flowchart shown in FIG. 3 for the second embodiment is the same as the flowchart shown in FIG. 2 for the first embodiment.

The performance recovery operation according to the second embodiment can produce performance recovery effects on the fuel cell stack 1 similar to those produced in the first embodiment.

### Comparative Example

A comparative example case in which a fuel cell stack similar to that described for the first and the second embodiment was used for continuous power generation without performing any performance recovery operation for its fuel cell stack has been compared with the first and the second embodiment.

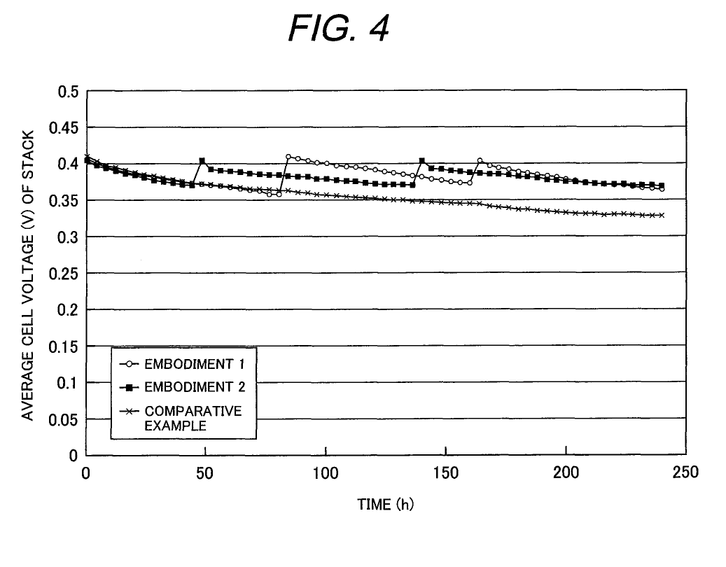

FIG. 4 compares variations with time of the average cell voltage of a fuel cell stack in three different cases; namely average cell voltage variations observed respectively with performance recovery operation performed for the fuel cell stack according to the first embodiment (denoted as EMBODIMENT 1 in FIG. 4), with performance recovery operation performed for the fuel cell stack according to the second embodiment (denoted EMBODIMENT 2 in FIG. 4), and with no performance recovery operation performed for the fuel cell stack (denoted COMPARATIVE EXAMPLE in FIG. 4). In all the three cases, power generation was conducted at 60° C. and with a methanol concentration of 10% and a load current density of 200 mA/cm².

Referring to FIG. 4, the curve denoted as EMBODIMENT 1 represents average cell voltage variation observed while the performance recovery operation of the flowchart shown in FIG. 2 was performed every 80 hours and the anode and cathode of each cell were connected for 30 seconds on every occasion of the performance recovery operation.

The curve denoted as EMBODIMENT 2 represents average cell voltage variation observed while the performance recovery operation of the flowchart shown in FIG. 3 was performed by setting a threshold cell voltage to 0.37 V and the anode and cathode of each cell were connected for 30 seconds on every occasion of the performance recovery operation. The curve denoted as COMPARATIVE EXAMPLE represents average cell voltage variation observed while power generation was continued without performing any performance recovery operation.

As is clear from FIG. 4, the performance recovery operations described in this specification can effectively inhibit the performance degradation of a fuel cell stack. Namely, the present invention makes it possible to use a DMFC for a long period of time in a stable state.

What is claimed is:

1. A fuel cell power system including a fuel cell stack in which a plurality of cells each having a membrane electrode assembly and a separator are stacked and a secondary battery which can be charged by power generated by the fuel cell stack and being capable of supplying power from one of the fuel cell stack and the secondary battery to an external device, the fuel cell power system comprising:
a power generation cell connection/disconnection mechanism for individually connecting and disconnecting a conductor for electrical conduction between an anode and a cathode of each cell included in the fuel cell stack; and
a control unit for controlling connection/disconnection operation performed by the power generation cell connection/disconnection mechanism.

2. The fuel cell power system according to claim 1, wherein, when power generation by the fuel cell stack is continued for a predetermined amount of time, the control unit: stops power generation by the fuel cell stack; stops air supply to the cathode of each cell included in the fuel cell stack; causes the power generation cell connection/disconnection mechanism to electrically connect the anode and cathode of each cell included in the fuel cell stack; breaks the electrical connection between the anode and cathode; resumes air supply to the cathode; and resumes power generation by the fuel cell stack.

3. The fuel cell power system according to claim 2, wherein the predetermined amount of time is in a range of one hour to 100 hours.

4. The fuel cell power system according to claim 2, wherein the anode and cathode of each cell included in the fuel cell stack are electrically connected for a period of time ranging from 10 seconds to 10 minutes.

5. The fuel cell power system according to claim 2, wherein, when power generation by the fuel cell stack is stopped, power is supplied from the secondary battery to an external device.

6. The fuel cell power system according to claim 1, further comprising a voltage sensor for measuring a voltage of the fuel cell stack.

7. The fuel cell power system according to claim 6, wherein, when a voltage measured by the voltage sensor is lower than a predetermined voltage value, the control unit: stops power generation by the fuel cell stack; stops air supply to the cathode of each cell included in the fuel cell stack; causes the power generation cell connection/disconnection mechanism to electrically connect the anode and cathode of each cell included in the fuel cell stack; breaks the electrical connection between the anode and cathode; resumes air supply to the cathode; and resumes power generation by the fuel cell stack.

8. The fuel cell power system according to claim 7, wherein the predetermined voltage value is in a range of 0.5 to 0.2 V per cell.

9. The fuel cell power system according to claim 7, wherein the anode and cathode of each cell included in the fuel cell stack are electrically connected for a period of time ranging from 10 seconds to 10 minutes.

10. The fuel cell power system according to claim 7, wherein, when power generation by the fuel cell stack is stopped, power is supplied from the secondary battery to an external device.

11. A method of operating a fuel cell power system including a fuel cell stack in which a plurality of cells each having a membrane electrode assembly and a separator are stacked and a secondary battery which can be charged by power generated by the fuel cell stack and being capable of supplying power from one of the fuel cell stack and the secondary battery to an external device;
wherein the fuel cell power system comprises a power generation cell connection/disconnection mechanism for individually connecting and disconnecting a conductor for electrical conduction between an anode and a cathode of each cell included in the fuel cell stack;
the method further comprising the steps of;
when power generation by the fuel cell stack is continued for a predetermined amount of time, stopping the power generation of the fuel cell stack, and stopping the air supply to the cathode of each cell included in the fuel cell stack after stopping the power generation;
electrically connecting the anode and cathode of each cell included in the fuel cell stack by the power generation cell connection/disconnection mechanism, and breaking the electrical connection between the anode and cathode; and
resuming the air supply to the cathode, and after that, resuming the power generation by the fuel cell stack.

12. The method of operating a fuel cell power system according to claim 11, wherein the predetermined amount of time is in a range of one hour to 100 hours.

13. The method of operating a fuel cell power system according to claim 11, wherein the anode and cathode of each cell included in the fuel cell stack are electrically connected for a period of time ranging from 10 seconds to 10 minutes.

14. The method of operating a fuel cell power system according to claim 11, wherein, when power generation by the fuel cell stack is stopped, power is supplied from the secondary battery to an external device.

15. The method of operating a fuel cell power system according to claim 11;
wherein the fuel cell power system has a voltage sensor for measuring a voltage of the fuel cell stack;
and the method further comprising the steps of;
when a voltage measured by the voltage sensor is lower than a predetermined voltage value, stopping the power generation of the fuel cell stack, and stopping the air supply to the cathode of each cell included in the fuel cell stack after stopping the power generation;
electrically connecting the anode and cathode of each cell included in the fuel cell stack by the power generation cell connection/disconnection mechanism, and breaking the electrical connection between the anode and cathode; and
resuming the air supply to the cathode, and after that, resuming the power generation by the fuel cell stack.

16. The method of operating a fuel cell power system according to claim 15, wherein the predetermined voltage value is in a range of 0.5 to 0.2 V per cell.

17. The method of operating a fuel cell power system according to claim 15, wherein the anode and cathode of each cell included in the fuel cell stack are electrically connected for a period of time ranging from 10 seconds to 10 minutes.

18. The method of operating a fuel cell power system according to claim 15, wherein, when power generation by the fuel cell stack is stopped, power is supplied from the secondary battery to an external device.
